(19) United States
(12) Patent Application Publication
(10) Pub. No.: US 2014/0111467 A1
(43) Pub. Date: Apr. 24, 2014

(54) IN-CELL TOUCH DISPLAY PANEL AND DRIVING METHOD THEREOF

(71) Applicant: AU Optronics Corp., Hsin-Chu (TW)

(72) Inventors: Yu-Ta Chen, Hsin-Chu (TW); Chao-Chen Wang, Hsin-Chu (TW); Chien-Ming Ko, Hsin-Chu (TW); Iru Wang, Hsin-Chu (TW); Tung-Tsun Lin, Hsin-Chu (TW); Yuan Mao, Hsin-Chu (TW)

(21) Appl. No.: 13/912,183

(22) Filed: Jun. 6, 2013

(30) Foreign Application Priority Data
Oct. 19, 2012 (TW) 101138816

(51) Int. Cl. G06F 3/044

(52) U.S. Cl. CPC G06F 3/044
USPC 345/174

(57) ABSTRACT

An in-cell touch display panel includes a plurality of first sensing electrodes, a pixel matrix, a plurality of second sensing electrodes, a touch control unit, and a display driving unit. The plurality of first sensing electrodes are for generating touch sensing signals according to touch scanning signals. The plurality of second sensing electrodes are utilized as common voltage electrodes of pixels of the pixel matrix. Wherein when the display driving unit drives pixels of a first block of the pixel matrix to display image, the display driving unit outputs a common voltage to the pixels of the first block via the second sensing electrodes corresponding to the first block, and outputs the touch scanning signals via the second sensing electrodes corresponding to a second block of the pixel matrix; and wherein the display driving unit switches a frequency of the touch scanning signals according to magnitude of a noise.

### BACKGROUND OF THE INVENTION

1. Field of the Invention

The disclosure relates to an in-cell touch display panel, and more particularly, to an in-cell touch display panel capable of reducing interference of noise.

2. Description of the Prior Art

An in-cell touch display panel is a display panel integrated with a touch control function. In order to perform the touch control function and a display function together, the in-cell touch display panel of the prior art outputs touch scanning signals via corresponding sensing electrodes to perform the touch control function during a first period within a scanning period of a scan line, and outputs a common voltage via corresponding sensing electrodes to perform the display function after the first period within the scanning period of the scan line.

However, when performing the touch control function, the in-cell touch display panel requires enough time to perform integral operations. When resolution of the in-cell touch display panel is higher, the scanning period of the scan line is shorter, such that the in-cell touch display panel does not have enough time to perform integral operations, so as to perform the touch control function incorrectly. In addition, when an electronic device including the in-cell touch display panel is charged by a charger, noises of the charger may interfere with signals of the in-cell touch display panel, so as to determine a touch position incorrectly.

### SUMMARY OF THE INVENTION

The disclosure provides an in-cell touch display panel, comprising a plurality of first sensing electrodes arranged along a first direction for generating touch sensing signals according to touch scanning signals; a pixel matrix having a plurality of pixels for displaying images; a plurality of second sensing electrodes arranged along a second direction and coupled to the pixel matrix; a touch control unit coupled to the plurality of first sensing electrodes for generating touch position data according to the touch sensing signals; and a display driving unit configured to drive the pixel matrix to display images, and output a common voltage or the touch scanning signals via the plurality of second sensing electrodes. Wherein when the display driving unit drives pixels of a first block of the pixel matrix to display image, the display driving unit outputs a common voltage to the pixels of the first block via the second sensing electrodes corresponding to the first block, and outputs the touch scanning signals via the second sensing electrodes corresponding to a second block of the pixel matrix; and wherein the display driving unit switches a frequency of the touch scanning signals according to magnitude of a noise.

The disclosure further provides a driving method of an in-cell touch display panel. The in-cell touch display panel comprises a plurality of first sensing electrodes arranged along a first direction for generating touch sensing signals according to touch scanning signals, a pixel matrix having a plurality of pixels for displaying images, and a plurality of second sensing electrodes arranged along a second direction and coupled to the pixel matrix. The driving method comprises driving pixels of a first block of the pixel matrix to display an image; when driving pixels of the first block of the pixel matrix to display the image, outputting a common voltage to the pixels of the first block via the second sensing electrodes corresponding to the first block, and outputting the touch scanning signals via the second sensing electrodes corresponding to a second block of the pixel matrix; and switching a frequency of the touch scanning signals according to magnitude of a noise.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a structure of an in-cell touch display panel of the disclosure.

FIG. 2 is a functional block diagram of the in-cell touch display panel of the disclosure.

FIG. 3 is a diagram showing the in-cell touch display panel of the disclosure performing touch control and display functions simultaneously.

FIG. 4 is a diagram showing the in-cell touch display panel of the disclosure simultaneously performing the touch control function and the display function.

FIG. 5 is a diagram showing the in-cell touch display panel of the disclosure switching frequency of the touch scanning signals.

FIG. 6 is a diagram showing a structure of an in-cell touch display panel according to another embodiment of the disclosure.

FIG. 7 is a flowchart showing the driving method of the in-cell touch display panel of the disclosure.

### DETAILED DESCRIPTION

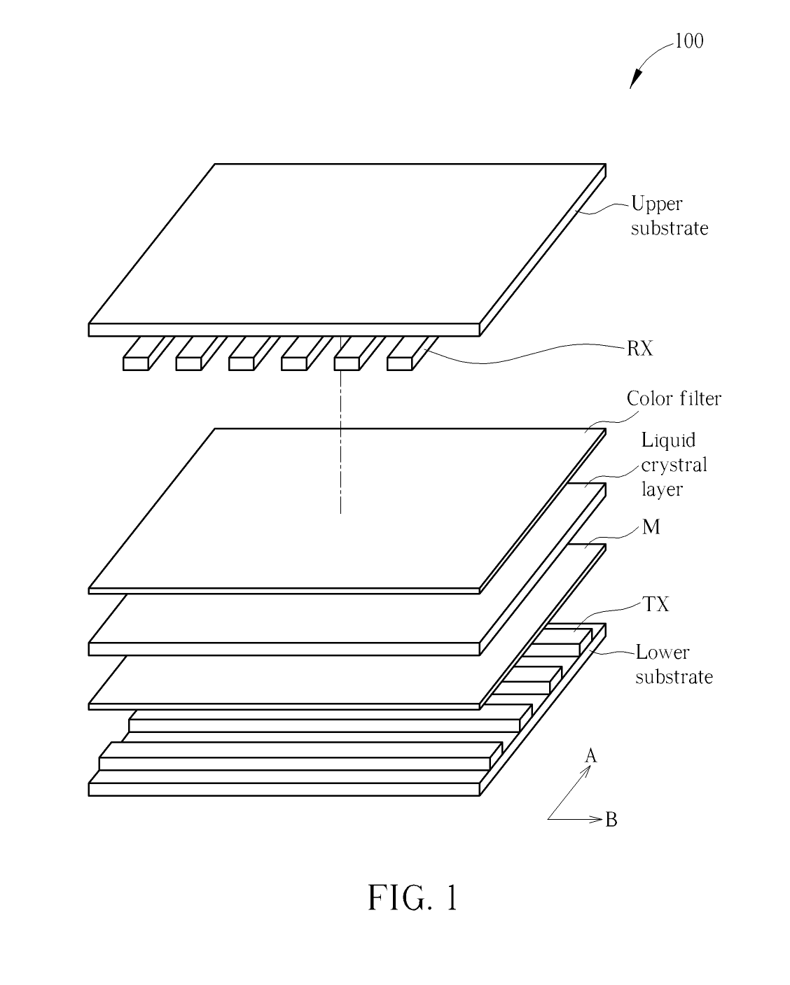

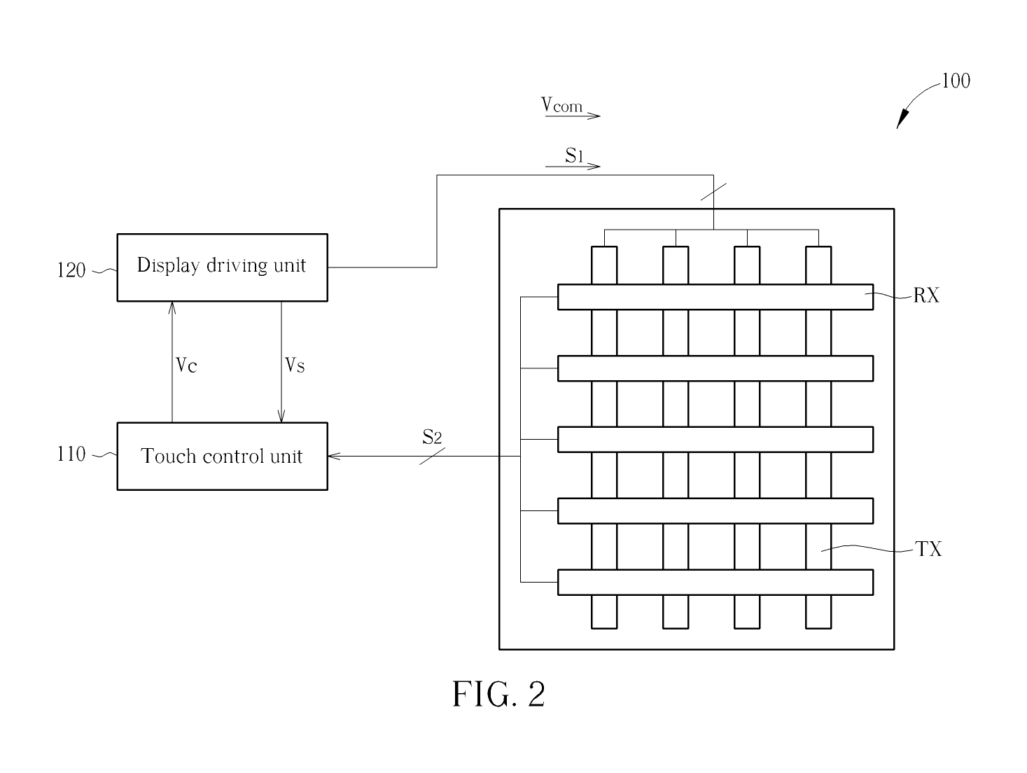

Please refer to FIG. 1 and FIG. 2 together. FIG. 1 is a diagram showing a structure of an in-cell touch display panel of the disclosure . FIG. 2 is a functional block diagram of the in-cell touch display panel of the disclosure. As shown in figures, the in-cell touch display panel 100 of the disclosure comprises a plurality of first sensing electrodes RX, a pixel matrix M, a plurality of second sensing electrodes TX, a touch control unit 110, and a display driving unit 120. The first sensing electrodes RX are arranged along a first direction A, and is configured to generate touch sensing signals S2 according to touch scanning signals S1 outputted by the second sensing electrodes TX. The pixel matrix comprises a plurality of pixels for displaying images. The second sensing electrodes TX are arranged along a second direction B and coupled to the pixel matrix M for being utilized as common voltage electrodes of the pixels of the pixel matrix. The touch control unit 110 is coupled to the plurality of first sensing electrodes RX for generating touch position data according to the touch sensing signals S2 of the first sensing electrodes RX. Besides driving the pixels of the pixel matrix M to display images, the display driving unit 120 is also configured to output a common voltage Vcom or the touch scanning signals S1 via the second sensing electrodes TX.

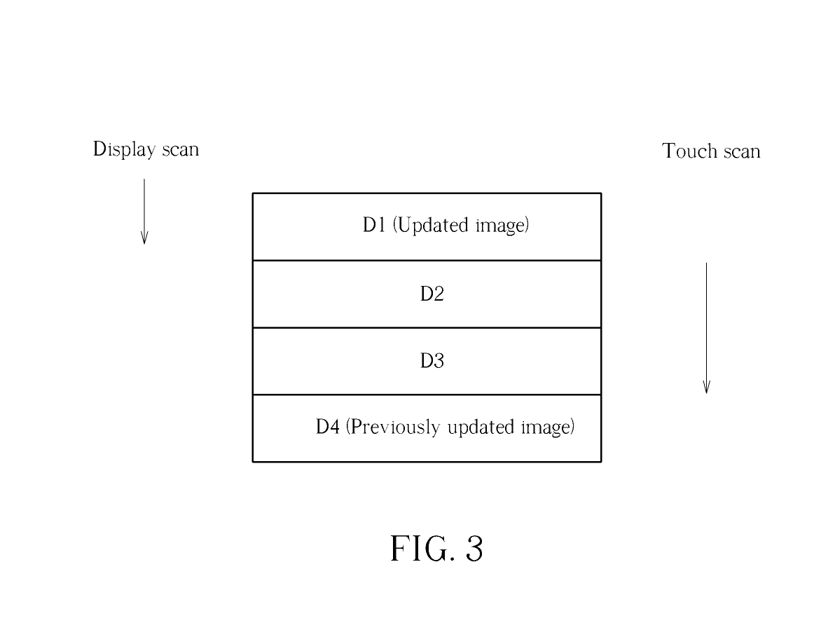

For example, please refer to FIG. 3, and refer to FIG. 1 and FIG. 2 as well. FIG. 3 is a diagram showing the in-cell touch display panel of the disclosure performing touch control and display functions simultaneously. As shown in FIG. 3, the pixel matrix M of the in-cell touch display panel of the disclosure can be divided into a plurality of blocks D1, D2, D3, D4. When the display driving unit 120 is driving the pixels of first block D1 of the pixel matrix M to display an image, the display driving unit 120 outputs the common voltage Vcom to the pixels of the first block D1 via the second sensing electrodes TX corresponding to the first block D1, and outputs the touch scanning signals S1 via the second sensing electrodes TX corresponding to the second block D2 and the third block D3 of the pixel matrix M, such that the in-cell touch display panel 100 of the disclosure can perform the display function at the first block D1, and perform the touch control function at the second block D2 and the third block D3. In addition, the fourth block D4 keeps displaying a previously updated image, and the display driving unit 120 also outputs the common voltage Vcom to the pixels of the fourth block D4 via the second sensing electrodes TX corresponding to the fourth block D4, in order to display the previously updated image.

According to the above arrangement, the touch control function can be continuously performed at the second block D2 and the third block D3 until scanning of all the scan lines of the first block D1 is complete, therefore, each of the second sensing electrodes TX corresponding to the second block D2 and the third block D3 has enough time to perform the integral operation, in order to avoid performing the touch control function incorrectly.

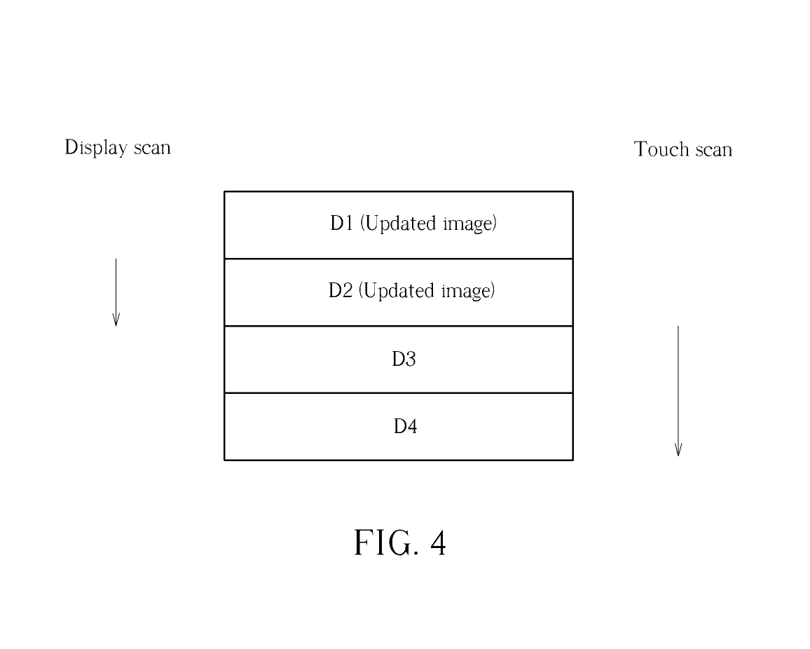

Similarly, as shown in FIG. 4, when the display driving unit 120 is driving the pixels of the second block D2 of the pixel matrix M to display the updated image, the display driving unit 120 outputs the common voltage Vcom to the pixels of the second block D2 via the second sensing electrodes TX corresponding to the second block D2, and outputs the touch scanning signals S1 via the second sensing electrodes TX corresponding to the third block D3 and the fourth block D4 of the pixel matrix M, such that the in-cell touch display panel 100 of the disclosure can perform the display function at the second block D2, and perform the touch control function at the third block D3 and the fourth block D4, and so on. In addition, the first block D1 continues to display the updated image, and the display driving unit 120 also outputs the common voltage Vcom to the pixels of the first block D1 via the second sensing electrodes TX corresponding to the first block D1, in order to display the updated image.

In the embodiment in FIG. 3 and FIG. 4, when the display driving unit 120 drives the pixels of one block of the pixel matrix M, the display driving unit 120 performs the touch control function at the other two blocks. However, in other embodiment of the disclosure, number of the blocks driven to perform the touch control function by the display driving unit 120 is not limited.

In addition, please refer to FIG. 2 again, the display driving unit 120 transmits a synchronous signal Vs to the touch control unit 110 for synchronizing with the touch control unit 110, and the display driving unit 120 then generates the touch scanning signals S1 according to a control signal Vc transmitted from the touch control unit 110.

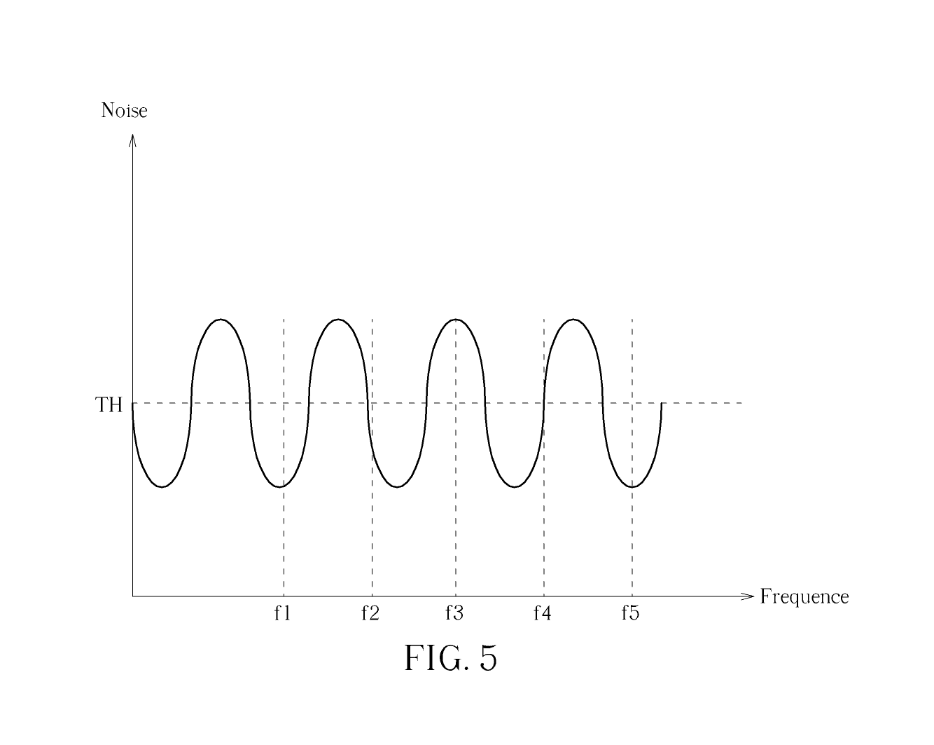

Please refer to FIG. 5. FIG. 5 is a diagram showing the in-cell touch display panel of the disclosure switching frequency of the touch scanning signals. When an electronic device including the in-cell touch display panel 100 of the disclosure is charged by a charger, and a frequency of noise of the charger is close to a frequency of the touch scanning signals, the noise of the charger may interfere with the touch scanning signals. When the frequency of the noise of the charger is close to the frequency of the touch scanning signals, the noise of the charger may be misidentified as the touch scanning signals, so as to determine a touch position incorrectly. As shown in FIG. 5, in order to prevent the touch scanning signals from inference of the noise of the charger or other type of noise, the in-cell touch display panel 100 of the disclosure can predetermine a plurality of preset frequencies f1, f2, f3, f4, f5 of the touch scanning signals, and switch the frequency of the touch scanning signals to one of the plurality of preset frequencies f1, f2, f3, f4, f5 according to magnitude of a noise, in order to avoid interference of the noise.

For example, if the frequency f3 of the touch scanning signals is close to the frequency of the charger noise during charging, in order to avoid interference of the charger noise, the display driving unit 120 will switch the frequency of the touch scanning signals to another preset frequency (such as f1, f2, f4, f5). If the magnitude of the charger noise is smaller than a threshold value TH at the next preset frequency, the display driving unit 120 keeps the frequency of the touch scanning signals at the next preset frequency in order to avoid interference of the charger noise; and if the magnitude of the charger noise is greater than the threshold value TH at the next preset frequency, the display driving unit 120 continues to switch the frequency of the touch scanning signals until the magnitude of the charger noise is smaller than the threshold value TH at some preset frequency.

Setting of the threshold value TH can be performed by scanning all preset frequencies to measure magnitudes of the charger noise at the corresponding preset frequencies, and then setting the threshold value TH according to the measured magnitudes of the charger noise at all preset frequencies. Thereafter, when the in-cell touch display panel of the disclosure operates, if the charger noise increases to be greater than the threshold value TH, and further cause the display driving unit to switch the frequency of the touch scanning signals to another preset frequency, the display driving unit will update the threshold value TH of the charge noise.

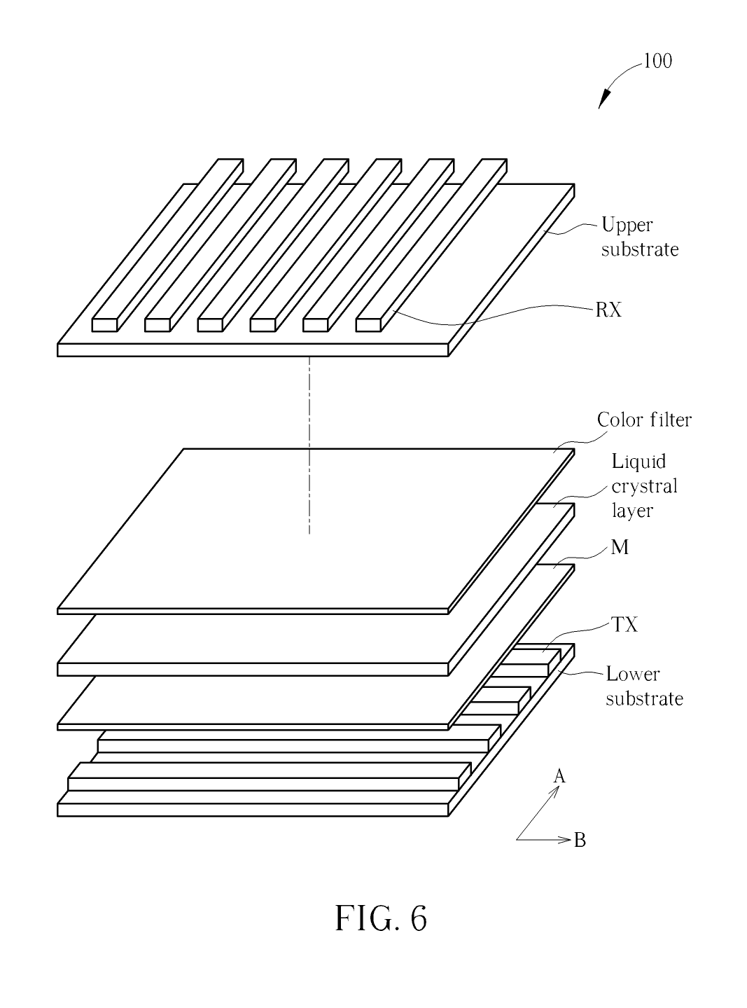

Please refer to FIG. 6. FIG. 6 is a diagram showing a structure of an in-cell touch display panel according to another embodiment of the disclosure. In the embodiment of FIG. 1, the first sensing electrodes RX are arranged under the upper substrate. However, in the embodiment of FIG. 6, the first sensing electrodes RX of the in-cell touch display panel 200 of the disclosure can also be arranged above the upper substrate.

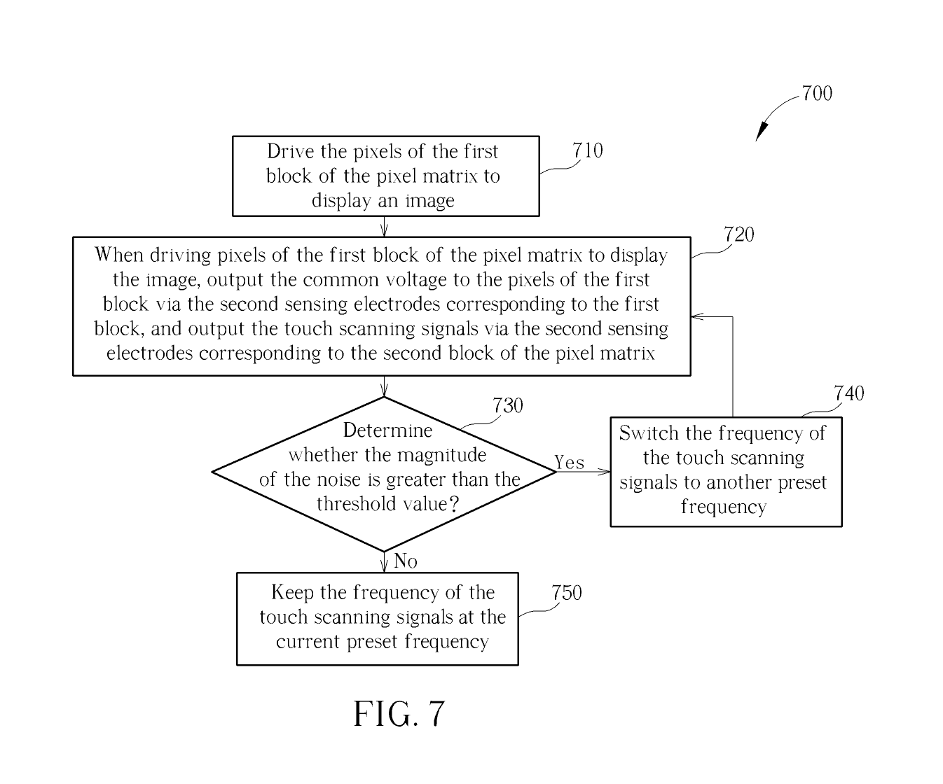

Please refer to FIG. 7. FIG. 7 is a flowchart 700 showing the driving method of the in-cell touch display panel of the disclosure. The flowchart of driving method of the in-cell touch display panel of the disclosure comprises the following steps:

Step 710: Drive the pixels of the first block of the pixel matrix to display an image;

Step 720: When driving pixels of the first block of the pixel matrix to display the image, output the common voltage to the pixels of the first block via the second sensing electrodes corresponding to the first block, and output the touch scanning signals via the second sensing electrodes corresponding to the second block of the pixel matrix;

Step 730: Determine whether the magnitude of the noise is greater than the threshold value; if yes, go to step 740; if not, go to step 750;

Step 740: Switch the frequency of the touch scanning signals to another preset frequency; and

Step 750: Keep the frequency of the touch scanning signals at the current preset frequency.

In contrast to the prior art, the in-cell touch display panel of the disclosure can simultaneously perform the display function and touch control function at different blocks , therefore, the in-cell touch display panel of the disclosure has enough time to perform integral operations. In addition, the in-cell touch display panel of the disclosure can switch the frequency of the touch scanning signals according to the magnitude of the noise for reducing interference of the noise, so as to avoid determining the touch position incorrectly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An in-cell touch display panel, comprising:
a plurality of first sensing electrodes, arranged along a first direction for generating touch sensing signals according to touch scanning signals;
a pixel matrix, having a plurality of pixels for displaying images;
a plurality of second sensing electrodes, arranged along a second direction and coupled to the pixel matrix;
a touch control unit, coupled to the plurality of first sensing electrodes for generating touch position data according to the touch sensing signals; and
a display driving unit, configured to drive the pixel matrix to display images, and output a common voltage or the touch scanning signals via the plurality of second sensing electrodes;
wherein when the display driving unit drives pixels of a first block of the pixel matrix to display image, the display driving unit outputs a common voltage to the pixels of the first block via the second sensing electrodes corresponding to the first block, and outputs the touch scanning signals via the second sensing electrodes corresponding to a second block of the pixel matrix; and
wherein the display driving unit switches a frequency of the touch scanning signals according to magnitude of a noise.

2. The in-cell touch display panel of claim 1, wherein the noise is a charger noise.

3. The in-cell touch display panel of claim 1, wherein the display driving unit switches the frequency of the touch scanning signals when the magnitude of the noise is greater than a threshold value.

4. The in-cell touch display panel of claim 1, wherein the display driving unit generates the touch scanning signals according to control signals of the touch control unit.

5. The in-cell touch display panel of claim 1, wherein the second sensing electrodes are common voltage electrodes of the plurality of pixels.

6. A driving method of an in-cell touch display panel, the in-cell touch display panel comprising a plurality of first sensing electrodes arranged along a first direction for generating touch sensing signals according to touch scanning signals, a pixel matrix having a plurality of pixels for displaying images, and a plurality of second sensing electrodes arranged along a second direction and coupled to the pixel matrix, the driving method comprising:
driving pixels of a first block of the pixel matrix to display an image;
when driving pixels of the first block of the pixel matrix to display the image, outputting a common voltage to the pixels of the first block via the second sensing electrodes corresponding to the first block, and outputting the touch scanning signals via the second sensing electrodes corresponding to a second block of the pixel matrix; and
switching a frequency of the touch scanning signals according to magnitude of a noise.

7. The driving method of claim 6, wherein switching the frequency of the touch scanning signals according to the magnitude of the noise comprises switching the frequency of the touch scanning signals when the magnitude of the noise is greater than a threshold value.

8. The driving method of claim 6 further comprising:
generating touch position data according to the touch sensing signals.

9. The driving method of claim 6 further comprising:
predetermining a plurality of preset frequencies of the touch scanning signals;
wherein switching the frequency of the touch scanning signals is switching the frequency of the touch scanning signals to one of the plurality of preset frequencies.

10. The driving method of claim 6, wherein the noise is a charger noise.

11. The driving method of claim 6, wherein outputting the touch scanning signals via the second sensing electrodes corresponding to the second block of the pixel matrix is outputting the touch scanning signals via the second sensing electrodes corresponding to the second block and a third block of the pixel matrix.
